(19) United States
(12) Patent Application Publication
(10) Pub. No.: US 2020/0171429 A1
(43) Pub. Date: Jun. 4, 2020

(54) SYSTEM FOR INERTING AT LEAST ONE VOLUME IN AN AIRCRAFT VIA AT LEAST ONE FUEL CELL

(71) Applicant: ZODIAC AEROTECHNICS, Roche La Moliere (FR)

(72) Inventors: Nelly Giroud, Saint-Just-Saint Rambert (FR); Pierrick Mailhet, Sorbiers (FR); Olivier Vandroux, Grenoble (FR)

(21) Appl. No.: 16/622,032

(22) PCT Filed: May 25, 2018
(86) PCT No.: PCT/EP2018/063747

§ 371 Date: Dec. 12, 2019

(30) Foreign Application Priority Data
Jun. 23, 2017 (FR) 1755776

(51) Int. Cl. B01D 53/32; H01M 8/0662; H01M 8/04828; B01D 53/26; A62C 3/08; A62C 5/00; A62C 99/00; B64D 37/32; B64D 41/00

(52) U.S. Cl. CPC B01D 53/326; H01M 8/0662; H01M 8/04843; B01D 53/265; B01D 53/268; B64D 2041/005; A62C 5/006; A62C 99/0018; B64D 37/32; B64D 41/00; A62C 3/08

(57) ABSTRACT

A system for inerting at least one volume in an aircraft includes at least one generator of inert gas fed with compressed air originating from a passenger cabin, and means for distributing the inert gas into the volume to be rendered inert, which are connected to the generator of inert gas. According to the invention, the generator of inert gas comprises a fuel cell including an outlet of oxygen-depleted gas connected to means for drying said gas.

### TECHNICAL FIELD

This system relates to the field of systems for inerting at least one volume, such as a fuel tank, cargo compartment, avionics bay, hidden area, or sheathing for electric cables, in an aircraft or similar.

### BACKGROUND

In the field of aeronautics, an inerting system is known for generating an inert gas, such as nitrogen or any other inert gas, for example carbon dioxide, and for injecting said inert gas into fuel tanks for safety reasons in order to reduce the risk of explosion of said tanks.

A conventional, prior art inerting system typically includes an on board inert gas generating system (OBIGGS) supplied with compressed air, for example, with compressed air diverted from at least one engine from a so-called intermediate pressure stage and/or a so-called high pressure stage based on a flight situation. The OBIGGS is connected to the airplane fuel tank and separates oxygen from the air.

The OBIGGS is composed of at least one air separating module containing, for example, permeable membranes such as polymer membranes passed over by an air flow. Due to the different permeabilities of the membrane to nitrogen and oxygen, the system splits the air flow so that an air flow with high nitrogen content and an air flow with high oxygen content are obtained. The air fraction enriched with nitrogen, considered to be the inert gas, is routed into fuel tanks so that the oxygen level present within the free volume of the tank is decreased. The devices required for this operation, such as compressors, filters, air- or liquid-cooling modules and similar, are integrated into the inert gas installation.

When the oxygen ratio in the empty part of the tank is below the ignition limit defined in accordance with the Federal Aviation Administration (FAA) requirements detailed in AC25.981-2A dated Sep. 19, 2008 entitled “FUEL TANK FLAMMABILITY REDUCTION MEANS” and its appendices, the ignition and deflagration risks are very low or even nonexistent. From the foregoing, inerting a fuel tank is composed of injecting an inert gas into the tank in order to maintain the level of oxygen present in said tank below a certain threshold, for example 12%.

In most cases, a conventional inerting system depends on the engine speeds and hence on the pressure profile available for the inerting system. The nitrogen-enriched inert gas generated at the outlet of the inert gas generator does not have a constant concentration of oxygen and depends on the pressure at the inlet of the inerting system.

Lastly, the inert gas at the outlet of the current inerting system does not enable a high flow rate and a low oxygen content to be combined. This is because, at the same operating pressure, an inert gas flowing at a low rate is purer, i.e. it has a lower oxygen content.

### SUMMARY OF THE DISCLOSURE

One of the aims of the disclosed embodiments is therefore to overcome the disadvantages of the prior art by providing an inert gas generator enabling an inert gas with a known and controlled oxygen content, and whose flow rate, purity and operating of the pressure profile system are independent, to be injected into at least one volume of an aircraft.

To this end, an inerting system is provided comprising at least one inert gas generator, supplied with compressed air from a passenger cabin, and means for distributing inert gas into the volume to be rendered inert, connected to the inert gas generator.

The inert gas generator comprises a fuel cell including an oxygen-depleted gas outlet connected to means for drying said inert gas, so that said inert gas can be injected into, for example, a fuel tank.

In this way, the disclosed embodiments enable a gaseous effluent from a fuel cell to be recovered, and to provide an alternative to the inerting systems of the prior art.

Furthermore, one advantage of a fuel cell is that the oxygen content present in the inert gas does not depend on the aircraft engine speed and hence does not depend on the pressure profile. The pressure of the inert gas at the fuel cell outlet fluctuates far less than with an inerting system bleeding air from the engines, and has no effect on the oxygen content present in the inert gas. The purity of the inert gas remains substantially constant. This is because, the oxygen content depends only on the fuel cell stoichiometry, and can easily be lower than 12%.

The inert gas therefore has a known and constant concentration of oxygen during the mission profile, and can just as well have a low or a high flow rate when the oxygen content is low.

Means for drying preferably comprise a heat exchanger. This is because the inert gas at the fuel cell outlet is hot, and cooling it enables water to be condensed and a first drying operation to be carried out.

According to the various embodiments, means for drying comprise two successive drying devices, i.e. at least one air/water separation membrane, or at least one enthalpy wheel, connected at the outlet of the heat exchanger.

This enables a second drying operation to be carried out, such that the water content in the inert gas is low and compatible with an injection into a fuel tank.

In this configuration, the heat exchanger enables water to be removed by condensation and gas to be prepared at temperature since the air/water separation membrane, for example, is not resistant to excessively high temperatures, above 65° C. In the event of the gas at the fuel cell outlet having a temperature lower than 65° C. and wherein the water content is compatible with a single drying device, the presence of the heat exchanger is not necessary. Thus, means for drying can be created directly by at least one air/water separation membrane, and/or an enthalpy wheel.

Another advantage is also that the fuel cell saves on air from the aircraft engines. This is because the fuel cell is supplied with compressed cabin air by an electric compressor.

### BRIEF DESCRIPTION OF THE FIGURES

Other advantages and features of the contemplated embodiments will appear more clearly from the following description, given as a non-restrictive example, with reference to the sole FIGURE appended, schematically illustrating an inerting system.

### DETAILED DESCRIPTION

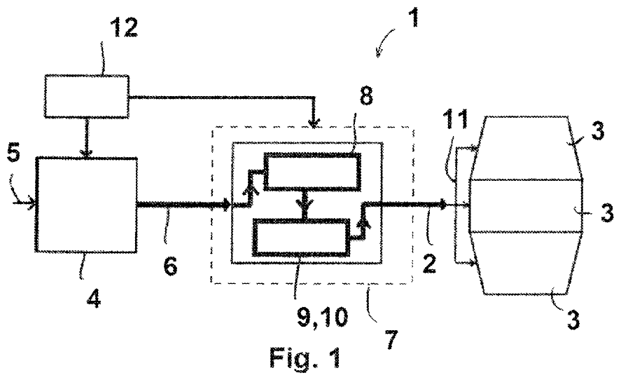

With reference to FIG. 1, which shows an inerting system (1) for injecting a flow of inert gas (2) into at least one volume (3), such as a fuel tank, a cargo compartment, an avionics bay, a hidden area, or sheathing for electric cables, in an aircraft or similar.

The inerting system (1) comprises a fuel cell (4) designed to be supplied with a reducing gas, such as hydrogen, and an oxidizing gas (5), such as air. In practice, the air originates from the passenger cabin of the aircraft, having been previously compressed by an electric compressor. At the outlet, the fuel cell (4) generates electricity, heat, water, and also oxygen-depleted humid air (6) destined to form the inert gas (2) to be injected into the volume (3) to be rendered inert. Depending on the aircraft, the mission profile, and the flight phase, the power of the fuel cell (4) is, for example, between 4 and 25 kW.

The fuel cell outlet is connected to means for drying (7) so that dry inert gas (2) can be injected into the volume (3) to be rendered inert, in particular a fuel tank. This is because, at the outlet of the fuel cell (4), hot, humid inert gas (6) cannot be injected in its unaltered state into a fuel tank.

The humid inert gas (6) is then channeled through a heat exchanger (8), which enables it to be cooled and hence a first drying operation to be carried out. The heat exchanger (8) can be any type, for example a condenser. As an example, and depending on the aircraft, the mission profile, and the flight phase, the condenser is sized such that it can absorb between 10 g and more than 70 g of water per kg of dry air.

According to the various embodiments, the cooled inert gas at the outlet of the heat exchanger (8) is channeled either through at least one air/water separation membrane (9) via permeation, or through at least one enthalpy wheel (10), enabling water to be absorbed to carry out a second drying step.

In practice, the air/water separation membrane (9) and the enthalpy wheel (10) are sized such that the remaining water content is between 1.90 g and 2.10 g of water per kg of dry air.

Simulations have shown that to be compatible with being injected into a fuel tank, the water content of the inert gas (2) must reach the value of 2 g of water per 1 kg of dry air, i.e. an inert gas (2) dew point of −10° C. below 1 bar absolute. Combining the heat exchanger (8) and the permeation membrane (9), or the heat exchanger (8) and the enthalpy wheel (10) enables such a water content to be achieved. The maximum value of 2 g of water per kg of dry air is set so as to ensure that the injection of dry air into the fuel tanks does not result in frosting phenomena.

The cooled inert gas (2) is dry at the outlet and can then be channeled to means for distributing (11) the inert gas (2) for injection in its unaltered state into the volume (3) to be rendered inert. The means for distribution (11) are well-known and consist of distribution pipes, various types of valves, such as check valves, etc. The injection into the volume (3) is, for example, carried out by injection nozzles. A controller (12), connected to the fuel cell (4) and to the various devices comprising means for drying (7), in particular the heat exchanger (8), the separation membrane (9) or the enthalpy wheel (10), the valves, the pressure and humidity sensors, enable the production and distribution of inerting gas (2) to be managed and controlled.

The inerting system (1) thus enables an inert gas (2) to be generated and injected into a volume (3) of an aircraft, for example a fuel tank, for safety reasons in order to reduce the risk of explosion of said volume (3). The inert gas (2) injected aims to render the volume (3) inert, i.e. it enables the oxygen content present in said tank(s) (2) to be reduced, and in particular to maintain this content below a certain threshold, for example lower than 12%.

The oxygen content present in the inert gas (2) does not depend on the aircraft engine speed and hence does not depend on the pressure profile. The pressure of the inert gas (2) at the outlet of the fuel cell (4) fluctuates far less than with an inerting system bleeding air from the engines, and has no effect on the oxygen content present in the inert gas (2). The purity of the inert gas (2) is known and remains substantially constant throughout the mission of the aircraft. It also saves on air from the aircraft engines.

The disclosed embodiments were achieved by going against certain prejudices, in particular the presence of pressurized hydrogen in an aircraft, installing new devices of yet to be proved maturity in the field of aeronautics, such as humidity sensors, air/water permeation membranes (9), managing humid air in a cold environment, and the fact of placing a fuel cell (4) into an aircraft without yet having had enough feedback on the average time between failures, and on the operating safety features.

1. A system for inerting at least one volume in an aircraft, said system comprising at least one inert gas generator, supplied with compressed air from a passenger cabin, and means for distributing the inert gas into the volume to be rendered inert, connected to the inert gas generator, wherein the insert gas generator comprises a fuel cell including an oxygen-depleted gas outlet connected to means for drying said gas.

2. A system in accordance with claim 1, wherein the means for drying comprise a heat exchanger.

3. A system in accordance with claim 1, wherein the means for drying comprise at least one air/water separation membrane.

4. A system in accordance with claim 1, wherein the means for drying comprise at least one enthalpy wheel.

5. A system in accordance with claim 1, wherein the means for drying comprise two successive drying devices.

6. A system in accordance with claim 5, wherein the means for drying comprise at least one air/water separation membrane connected to the outlet of a heat exchanger.

7. A system in accordance with claim 5, wherein the means for drying comprise at least one enthalpy wheel connected to the outlet of a heat exchanger.
